(19) United States
(12) Patent Application Publication
(10) Pub. No.: US 2017/0070648 A1
(43) Pub. Date: Mar. 9, 2017

(54) COLORIMETRY METHOD, COLORIMETRY DEVICE, AND PRINTING APPARATUS

(71) Applicant: Seiko Epson Corporation, Tokyo (JP)

(72) Inventor: Tetsuo TATSUDA, Ina (JP)

(21) Appl. No.: 15/249,909

(22) Filed: Aug. 29, 2016

(30) Foreign Application Priority Data
Sep. 3, 2015 (JP) 2015-173663

(51) Int. Cl. H04N 1/60

(52) U.S. Cl. CPC H04N 1/6044; H04N 2201/0082

(57) ABSTRACT

A colorimetry method includes: acquiring spectroscopic measurement results for a colorimetry range in an image; and acquiring colorimetry results for a first color based on the spectroscopic measurement results for the first color from a plurality of colors in a case where the plurality of colors is included in the colorimetry range.

### BACKGROUND

1. Technical Field

The present invention is related to a colorimetry method, a colorimetry device, and a printing apparatus.

2. Related Art

In the related art, technologies are known that carry out colorimetry on a measurement object, such as an image or printed matter or the like displayed on an image display device and that acquire the colorimetry results (JP-A-2005-114531).

In the image display device and image display method disclosed in JP-A-2005-114531, the measurement object is imaged with a multiband camera, thereby acquiring a multiband image that includes band images corresponding to each of a plurality of wavelengths (bands). A band image corresponding to one band from the acquired multiband image is displayed. The spectrum of a designated area designated by a user from the displayed band image is estimated using each band image of the multiband image and is displayed.

In the devices disclosed in JP-A-2005-114531, the reflectivity of the designated band of the designated area is calculated based on the average value of a signal value of each pixel in the designated area when the object image is imaged and the average value of the signal value of each pixel in the designated area when a reference image is imaged. The spectrum in the designated area of the measurement object is estimated based on the reflectivity calculated for each band. The chromaticity value is calculated using the spectrum designated in this way, and the colorimetry results are acquired.

However, in the device disclosed in JP-A-2005-114531, because the reflectivity of each band in the designated area is calculated as an average value, in a case where a plurality of colors is included in the designated area, the average value is calculated as the reflectivity based on the signal value for the plurality of colors and the estimated precision of the spectrum, that is, the colorimetry precision is lowered. In a case of carrying out colorimetry on an arbitrary measurement object, there are problems that there is a high potential of a plurality of colors being included in the designated area and it is difficult to carry out high precision colorimetry.

### SUMMARY

An advantage of some aspects of the invention is to provide a colorimetry method, a colorimetry device, and a printing apparatus capable of carrying out high precision colorimetry.

According to an application example of the invention, there is provided a colorimetry method including: acquiring spectroscopic measurement results for a colorimetry range in an image; and acquiring colorimetry results for a first color based on the spectroscopic measurement results for the first color from a plurality of colors, in a case where the plurality of colors is included in the colorimetry range.

Here, the colorimetry results are the spectral spectrum for each color in the colorimetry range, the colorimetry value digitized according to various color systems, the color difference of another pixel to the reference pixel, or the like.

The colorimetry range is at least a portion of the image.

In the application example, the spectroscopic measurement results for the colorimetry range are acquired when acquiring the colorimetry results for the colorimetry range in the image. In a case where a plurality of colors is included in the colorimetry range, the colorimetry results for a first color are obtained based on the spectroscopic measurement results for the first color from the plurality of colors. Accordingly, high precision colorimetry results can be obtained compared to the related art that estimates the spectrum based on an average value of the signal value of all pixels in the colorimetry range as the same color without discriminating each color regardless of whether a plurality of colors is included in the colorimetry range.

In the application example, acquiring the colorimetry results for the colorimetry range in the spectroscopic measurement results acquired and stored in advance, and newly obtaining spectroscopic measurement results by carrying out spectroscopic measurement of a region corresponding to the colorimetry range in the measurement object (for example, imaging a spectroscopic image) are included in the acquiring of the spectroscopic measurement results.

It is preferable that the colorimetry method of the application example further includes determining whether or not the plurality of colors is included in the colorimetry range.

In the application example, whether or not a plurality of colors is included in the colorimetry range is determined. Accordingly, as a result of determining whether a plurality of colors is included in the colorimetry range, in a case where it is determined that a plurality of colors is included, colorimetry results for a first color can be acquired using spectroscopic measurement results pertaining to the first color from the plurality of colors.

In the colorimetry method of the application example, it is preferable that, in the acquiring of the spectroscopic measurement results, spectroscopic images with a plurality of wavelengths for the colorimetry range are acquired and, in the determining, whether or not a plurality of colors is included based on a brightness value of each pixel of a spectroscopic image with a predetermined wavelength from the spectroscopic images with a plurality of wavelengths for the colorimetry range is determined.

In the application example, whether a plurality of colors is included is determined based on the brightness value of each pixel of the acquired spectroscopic image. That is, whether a plurality of colors is included can be easily determined by using the brightness value of each pixel for each of the predetermined wavelengths (for example, three wavelengths corresponding to three colors such as red, green, and blue) compared to a case of comparing colors by calculating the colorimetry value (such as chromaticity or color difference) of each pixel. An increase in the processing load due to determining whether or not a plurality of colors is included can be suppressed.

In the colorimetry method of the application example, it is preferable that, in the determining, whether or not a plurality of colors is included based on a difference in the brightness values between a reference pixel and a comparison pixel included in the colorimetry range for the spectroscopic image with a predetermined wavelength is determined.

In the application example, whether a plurality of colors is included is determined based on the difference in the brightness values between the reference pixel and the comparison pixel in the colorimetry range. In this way, determining whether or not the color of the pixel included in the colorimetry range is the same can be performed, and determining whether a plurality of colors is included in the colorimetry range can be performed by using the difference in the brightness values between the reference pixel and the comparison pixel.

An increase in the processing load due to the determining whether or not a plurality of colors is included can be suppressed compared to a case of calculating the colorimetry results such as the colorimetry value (such as chromaticity or color difference) or the spectral spectrum for all of the comparison pixels and comparing the calculated colorimetry results.

In the colorimetry method of the application example, it is preferable that the reference pixel is a pixel included in the colorimetry range, and in the determining, it is determined that the colors of the reference pixel and the comparison pixel are different in a case where the difference between the reference pixel and the comparison pixel exceeds a threshold.

In the application example, it is determined that the colors of the reference pixel and the comparison pixel are different in a case where a pixel included in the colorimetry range is used as the reference pixel, and the difference between the reference pixel and the comparison pixel exceeds a threshold. In this way, determining whether the color is the same between the reference pixel and the comparison pixel can be easily performed by calculating the difference in the brightness values between the reference pixel and the comparison pixel and comparing the result to a threshold.

Determination that a plurality of colors is included in the colorimetry range can be performed at the point in time where determining whether the color of the reference pixel and the comparison pixel is the same is carried out and a comparison pixel that is determined to be different is present.

In the colorimetry method of the application example, it is preferable that, in the acquiring of the spectroscopic measurement results, spectroscopic images with a plurality of wavelengths are acquired and, in the determining, whether or not a plurality of colors is included based on the brightness value of a first pixel of the spectroscopic image with a first wavelength and the brightness value of a second pixel of the spectroscopic image with the first wavelength from the spectroscopic images with a plurality of wavelengths, and the brightness value of the first pixel of a spectroscopic image with a second wavelength, and the brightness value of the second pixel of the spectroscopic image with the second wavelength from the spectroscopic images with a plurality of wavelengths is determined.

In the application example, whether or not a plurality of colors is included is determined based on the brightness value of a first pixel of a spectroscopic image with a first wavelength and the brightness value of a second pixel of a spectroscopic image with a first wavelength and the brightness value of a first pixel of a spectroscopic image with a second wavelength and the brightness value of a second pixel of a spectroscopic image with a second wavelength from the acquired spectroscopic images. For example, the brightness value of the first wavelength and the brightness value of the second wavelength can be compared for each of the first pixels and the second pixels, and, in a case where the brightness values are different, it can be determined that each pixel thereof is a pixel corresponding to a different color. In this way, by determining whether the colors are different based on the brightness values in the first and second wavelengths of each pixel, whether a plurality of colors is included can be easily determined compared to a case where the colorimetry value (such as the chromaticity value or color difference) of each pixel is calculated and the colors are compared. An increase in the processing load due to the determining whether or not a plurality of colors is included can be suppressed.

It is preferable that the colorimetry method of the application example further includes acquiring spectroscopic images with a plurality of wavelengths for an object; and generating a color image as the image by synthesizing the spectroscopic images with a plurality of wavelengths.

According to the application example, spectroscopic images with a plurality of wavelengths are acquired, and the acquired spectroscopic images are synthesized, thereby generating a color image. In this way, a color image can be generated from spectroscopic images with a plurality of wavelengths obtained by imaging an object. Accordingly, processing such as the colorimetry range being selected can be carried out while the generated color image is displayed on a display unit and referenced by a user, and the operability can be improved.

In the colorimetry method of the application example, it is preferable that, in the acquiring of the colorimetry results, the colorimetry results for the first color in the colorimetry range are acquired as the average value.

In the application example, the colorimetry results for the first color in the colorimetry range are acquired as an average value. In the configuration, it is possible to suppress the influence of noise and to acquire colorimetry results with greater accuracy compared to a case of acquiring the colorimetry results for each pixel.

In the colorimetry method of the application example, it is preferable that, in the acquiring of the colorimetry results, the respective colorimetry results for the plurality of colors and the occupancy ratio in the colorimetry range are acquired in a case where a plurality of colors is included in the colorimetry range.

In the application example, the colorimetry results for each color and the occupancy ratio in the colorimetry range are acquired in a case where a plurality of colors is included in the colorimetry range. In such a configuration, because the colorimetry results for each color and the occupancy ratio are acquired, for example, when the colorimetry results are output to a display unit or the like, the colorimetry results and the occupancy ratio can be displayed and the occupancy ratio can be displayed in ascending order associated with the order of the colorimetry results. In this way, a user can verify not only the colorimetry results for each color but also the occupancy ratio of colors forming the colorimetry range as the colorimetry results for the colorimetry range.

According to another application example of the invention, there is provided a colorimetry device that is configured to: acquire spectroscopic measurement results for a colorimetry range in an image; and acquire colorimetry results based on the spectroscopic measurement results for a first color from the plurality of colors in a case where a plurality of colors is included in the colorimetry range.

In the application example, the spectroscopic measurement results for the colorimetry range are acquired when acquiring the colorimetry results for the colorimetry range in the image. In a case where a plurality of colors is included in the colorimetry range, the colorimetry results for a first color are obtained based on the spectroscopic measurement results for the first color from the plurality of colors. Accordingly, high precision colorimetry results can be obtained compared to the related art that estimates the spectrum based on an average value of the signal value of all pixels in the colorimetry range as the same color without discriminating each color regardless of whether a plurality of colors is included in the colorimetry range.

According to still another application example of the invention, there is provided a printing apparatus including: the colorimetry device of the above-described application example; and a printing unit that prints an image as an object on a medium.

In the printing apparatus according to the application example of the invention, the spectroscopic measurement results for the colorimetry range are acquired when acquiring the colorimetry results for the colorimetry range in the image. In a case where a plurality of colors is included in the colorimetry range, the colorimetry results for a first color are obtained based on the spectroscopic measurement results for the first color from the plurality of colors. Accordingly, high precision colorimetry results can be obtained compared to the related art that estimates the spectrum based on an average value of the signal value of all pixels in the colorimetry range as the same color without discriminating each color regardless of whether a plurality of colors is included in the colorimetry range. The colorimetry results for an image printed on a medium by the printing unit can be acquired with high precision.

### BRIEF DESCRIPTION OF THE DRAWINGS

The invention will be described with reference to the accompanying drawings, wherein like numbers reference like elements.

FIG. 1 is a block diagram illustrating a schematic configuration of a colorimetry device of a first embodiment of the invention.

FIG. 2 is a plan view illustrating a schematic configuration of a variable wavelength interference filter of the first embodiment.

FIG. 3 is a cross-sectional view illustrating the schematic configuration of the variable wavelength interference filter taken along line III-III in FIG. 2.

FIG. 4 is a flowchart illustrating the colorimetry method in the colorimetry device of the first embodiment.

FIGS. 5A to 5C are drawings schematically illustrating an imaged image and a colorimetry range in the imaged image in the colorimetry device of the first embodiment.

FIG. 6 is a drawing illustrating an example of a method of determining whether the colors are the same between a reference pixel and a comparison pixel.

FIG. 7 is a drawing illustrating an example of the colorimetry results displayed on a display unit.

FIG. 8 is a flowchart illustrating the colorimetry method in the colorimetry device of a second embodiment of the invention.

FIG. 9 is an external view illustrating a schematic configuration of a printer of a third embodiment of the invention.

FIG. 10 is a block diagram illustrating a schematic configuration of the printer of the third embodiment.

### DESCRIPTION OF EXEMPLARY EMBODIMENTS

### First Embodiment

Below, the colorimetry device of the first embodiment according to the invention will be described based on the drawings.

### Configuration of Colorimetry Device

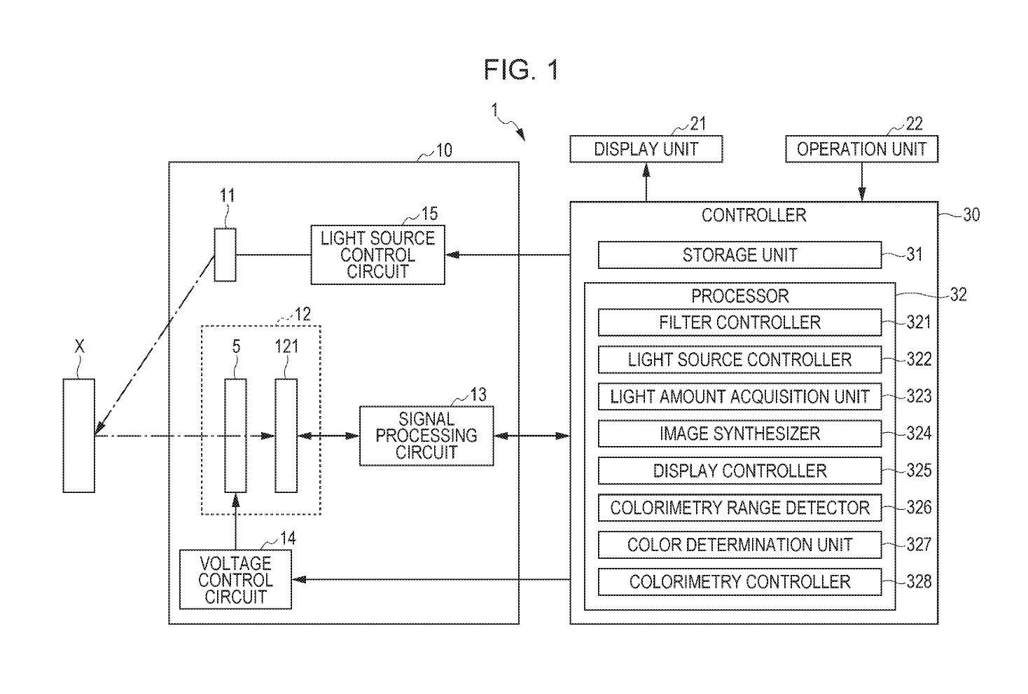

FIG. 1 is a block diagram illustrating a schematic configuration of the colorimetry device according to the first embodiment.

The colorimetry device 1 is provided with an optical module 10, a display unit 21, an operation unit 22 and a controller 30 that controls the optical module 10 and the display unit 21 and that processes signals output from the optical module 10, as illustrated in FIG. 1.

The colorimetry device 1 is a device that irradiates a measurement object X with light, captures a spectroscopic image with each wavelength in the measurement object light reflected by the measurement object X, and that performs colorimetry of a predetermined range in the imaging range. Specifically, the colorimetry device 1 acquires spectroscopic images of the measurement object X at a plurality of wavelengths, a color image in which the spectroscopic images corresponding to each of at least red (R), green (G), and blue (B) for a plurality of wavelengths are synthesized is displayed on the display unit 21, and colorimetry is carried out in the measurement object range designated by the operation of an operator.

### Configuration of Optical Module

The optical module 10 is provided with a light source unit 11, an imaging unit 12, a signal processing circuit 13, a voltage control circuit 14, and a light source control circuit 15. The imaging unit 12 is provided with a variable wavelength interference filter 5 and an imaging element 121.

The optical module 10 irradiates the measurement object X with radiated light from the light source unit 11, the measurement object light reflected by the measurement object X passes through an incident optical system (not shown) and is guided to the variable wavelength interference filter 5 of the imaging unit 12, and the light passing through the variable wavelength interference filter 5 is received by the imaging element 121. The detection signal output from the imaging element 121 is output to the controller 30 via the signal processing circuit 13.

### Configuration of Light Source Unit

The light source unit 11 radiates white light and irradiates the measurement object X. The light source unit is formed of three LEDs of red, green, and blue. It should be noted that a white LED in which a blue LED and a phosphor that generates yellow light with blue light from the blue LED as pumping light are combined, a white LED that obtains white light by causing red, green and blue luminous elements to generate light with a violet LED, or the like may be used. For example, another light source such as a halogen lamp may be used as the light source unit 11.

### Configuration of Variable Wavelength Interference Filter of Imaging Unit

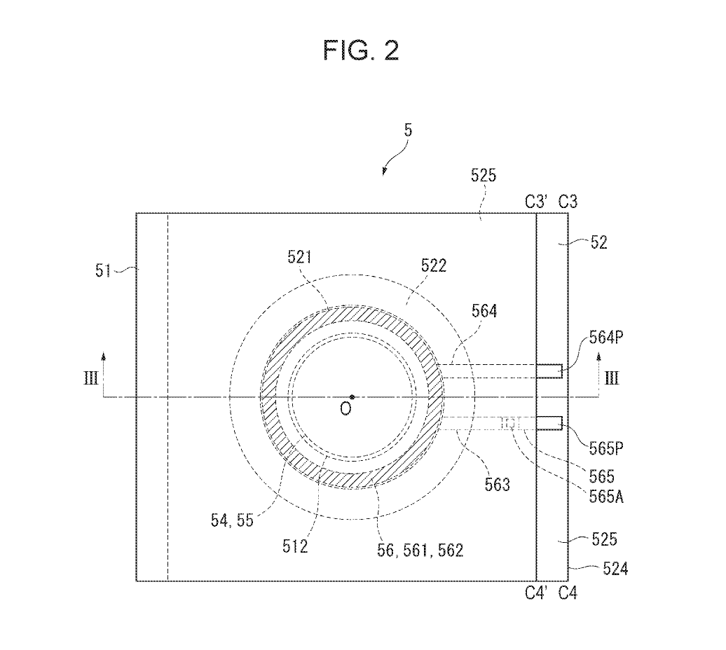

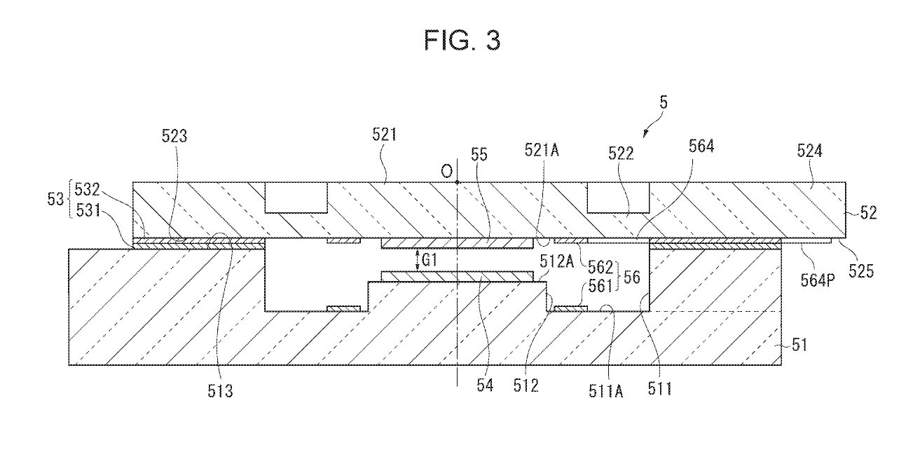

FIG. 2 is a plan view illustrating a schematic configuration of the variable wavelength interference filter 5. FIG. 3 is a cross-sectional view illustrating the schematic configuration of the variable wavelength interference filter 5 taken along line III-III in FIG. 2.

The variable wavelength interference filter 5 is provided with a fixed substrate 51 and a movable substrate 52, as illustrated in FIGS. 2 and 3. The fixed substrate 51 and the movable substrate 52 are each formed of various glasses, a liquid crystal or the like, and in the embodiment, are formed of a quartz glass. The substrates 51 and 52 are integrally formed by being bonded by a bonding film 53 (first bonding film 531 and second bonding film 532), as illustrated in FIG. 3. Specifically, the first bonding section 513 of the fixed substrate 51 and the second bonding section 523 of the movable substrate 52 are bonded by a bonding film 53 formed of a plasma polymerization film or the like with siloxane as a main component.

It should be noted that, in the following description, the plan view seen from the substrate thickness direction of the fixed substrate 51 or the movable substrate 52, that is the plan view in which the variable wavelength interference filter 5 is viewed from the layering direction of the fixed substrate 51, the bonding film 53, and the movable substrate 52 is referred to as the filter plan view.

A fixed reflection film 54 that forms one of a pair of reflection films in the invention is provided on the fixed substrate 51, as illustrated in FIG. 3. A movable reflection film 55 that forms the other of the pair of reflection films in the invention is provided on the movable substrate 52. The fixed reflection film 54 and the movable reflection film 55 are arranged facing each other with a gap G1 interposed between the reflection films.

An electrostatic actuator 56 that is used in adjusting the distance of the gap G1 (gap dimensions) between the reflection films 54 and 55 and is a gap changing portion of the invention is provided on the variable wavelength interference filter 5. The electrostatic actuator 56 is provided with a fixed electrode 561 provided on the fixed substrate 51 and a movable electrode 562 provided on the movable substrate 52, and is formed by each electrode 561 and 562 facing one another. The fixed electrode 561 and movable electrode 562 face each other with a gap interposed between the electrodes. Here, the electrodes 561 and 562 may have a configuration provided directly on the substrate surface of the fixed substrate 51 and the movable substrate 52 or may have a configuration provided with another film member interposed.

It should be noted that although a configuration in which the gap G1 between the reflection films is smaller than the gap between the electrodes is given as an example in the embodiment, the gap G1 between the reflection films may be formed larger than the gap between the electrodes according to the wavelength region allowed to pass through by the variable wavelength interference filter 5.

One side of the movable substrate 52 (for example, side C3-C4 in FIG. 2) protrudes further to the outside than side C3′-C4′ of the fixed substrate 51 in the filter plan view. The protrusion portion of the movable substrate 52 is an electrical unit 524 that is not bonded to the fixed substrate 51, and the surface that is exposed when the variable wavelength interference filter 5 is viewed from the fixed substrate 51 side is the electrical surface 525 on which the electrode pads 564P and 565P, described later, are provided.

Similarly, one side (opposite side to the electrical unit 524) of the fixed substrate 51 protrudes further to the outside than the movable substrate 52 in filter plan view.

### Configuration of Fixed Substrate

An electrode arrangement groove 511 and a reflection film installation section 512 are formed by etching on the fixed substrate 51. The fixed substrate 51 is formed with a greater thickness dimension than the movable substrate 52, and there is no electrostatic attractive force when a voltage is applied between the fixed electrode 561 and the movable electrode 562 or distortion of the fixed substrate 51 due to internal stress of the fixed electrode 561.

The electrode arrangement groove 511 is formed in annular shape with the filter center point of the fixed substrate 51 as a center in filter plan view. The reflection film installation section 512 is formed to be projected from the center portion of the electrode arrangement groove 511 to the movable substrate 52 side in plan view. The groove bottom surface of the electrode arrangement groove 511 is the electrode installation surface 511A on which the fixed electrode 561 is arranged. The protrusion tip surface of the reflection film installation section 512 is the reflection film installation surface 512A.

The fixed electrode 561 that forms the electrostatic actuator 56 is provided on the electrode installation surface 511A. The fixed electrode 561 is provided on a region that faces the movable electrode 562 of the movable portion 521, described later, from the electrode installation surface 511A. A configuration may be used in which an insulating film for ensuring insulation between the fixed electrode 561 and the movable electrode 562 is layered on the fixed electrode 561.

A fixed extraction electrode 563 connected to the outer peripheral edge of the fixed electrode 561 is provided on the fixed substrate 51. The fixed extraction electrode 563 is provided along the connection electrode groove (not shown) that is formed from the electrode arrangement groove 511 toward the side C3′-C4′ (electrical section 524 side). A bump portion 565A that protrudes toward the movable substrate 52 side is provided in the connection electrode groove, and the fixed extraction electrode 563 extends onto the bump portion 565A. The fixed connection electrode 565 provided on the movable substrate 52 side comes abuts onto the bump portion 565A and is electrically connected. The fixed connection electrode 565 is extracted from the region that faces the connection electrode groove as far as the electrical surface 525 and forms the fixed electrode pad 565P in the electrical surface 525.

It should be noted that although a configuration in which one fixed electrode 561 is provided on the electrode installation surface 511A is illustrated in the embodiment, a configuration (double electrode configuration) in which two concentric electrodes with the filter center point as a center are disposed may be used. In addition, a configuration in which a transparent electrode is provided on the fixed reflection film 54, or a configuration in which a conductive fixed reflection film 54 is used and a connection electrode may be formed from the fixed reflection film 54 to the fixed side electrical portion, and in this case, a portion is cut out according to the position of the connection electrode as the fixed electrode 561 may be used.

The reflection film installation section 512 is formed in a substantially cylindrical shape with a smaller radius dimension than the electrode arrangement groove 511 on the same axis as the electrode arrangement groove 511, as described above, and is provided with the reflection film installation surface 512A that faces the movable substrate 52 of the reflection film installation section 512.

The fixed reflection film 54 is installed on the reflection film installation section 512 as illustrated in FIG. 3. It is possible to use a metal film, such as Ag, or an alloy film, such as an Ag alloy, as the fixed reflection film 54. For example, a dielectric multilayer film in which the high refraction layer is TiO₂ and the low refraction layer is SiO₂ may be used. Furthermore, a reflection film in which a metal film (or an alloy film) is layered on the dielectric multilayer film, a reflection film in which the dielectric multilayer film is layered on the metal film (or alloy film), a reflection film in which a single refraction layer (such as TiO₂ or SiO₂) and a metal film (or an alloy film) are layered, or the like may be used.

An anti-reflection film may be formed at a position corresponding to the fixed reflection film 54 on the light incident surface (surface on which the fixed reflection film is not provided) of the fixed substrate 51. It is possible for the anti-reflection film to be formed by alternately layering the low refractive index film and the high refractive index film, and the reflectivity of visible light by the surface of the fixed substrate 51 is lowered and the transmissivity is increased.

The surface on which the electrode arrangement groove 511, the reflection film installation section 512, and the connection electrode groove are not formed by etching from the surface that faces the movable substrate 52 of the fixed substrate 51 forms the first bonding section 513. The first bonding film 531 is provided on the first bonding section 513, and the fixed substrate 51 and the movable substrate 52 are bonded as described above by the first bonding film 531 being bonded to the second bonding film 532 provided on the movable substrate 52.

### Configuration of Movable Substrate

The movable substrate 52 is provided with a circular movable portion 521 with the filter center point as a center, and a holding section 522 that holds the movable portion 521 on the same axis as the movable portion 521.

The movable portion 521 is formed with a larger thickness dimension than the holding section 522. The movable portion 521 is formed with a larger radial dimension than the radial dimension of the outer peripheral surface of at least the reflection film installation surface 512A in filter plan view. The movable electrode 562 and the movable reflection film 55 are provided on the movable portion 521.

It should be noted that an anti-reflection film may be formed on the surface of the side opposite the fixed substrate 51 of the movable portion 521, similarly to the fixed substrate 51. It is possible for the anti-reflection film to be formed by alternately stacking the low refractive index film and the high refractive index film, and for the reflectivity of visible light by the surface of the movable substrate 52 to be lowered and the transmissivity to be increased.

The movable electrode 562 faces the fixed electrode 561 with a predetermined gap between the electrodes interposed and is formed in an annular shape that is the same shape as the fixed electrode 561. The movable electrode 562 forms an electrostatic actuator 56 along with the fixed electrode 561. The movable connection electrode 564 connected to the outer peripheral edge of the movable electrode 562 is provided on the movable substrate 52. The movable connection electrode 564 is provided across the electrical surface 525 following a position facing the connection electrode groove (not shown) provided on the fixed substrate 51 from the movable portion 521, and forms the movable electrode pad 564P in the electrical surface 525.

The fixed connection electrode 565 is provided on the movable substrate 52 as described above, and the fixed connection electrode 565 is connected to the fixed extraction electrode 563 with the bump portion 565A (refer to FIG. 2) interposed.

The movable reflection film 55 is provided to face the fixed reflection film 54 with therebetween the gap G1 interposed at the center portion of the movable surface 521A of the movable portion 521. A reflection film with the same configuration as the above-described fixed reflection film 54 is used as the movable reflection film 55.

It should be noted that although an example in which the gap between the electrodes is larger than the dimensions of the gap G1 between the reflection films is illustrated in the embodiment as described above, there is no limitation thereto. For example, in cases of using infrared rays or far infrared rays, or the like, a configuration in which the dimensions of the gap G1 become larger than the dimensions of the gap between the electrodes may be used according to the acquired object wavelength region of the spectroscopic image.

The holding section 522 is a diaphragm that surrounds the periphery of the movable portion 521, and is formed with the thickness dimensions smaller than the movable portion 521. Such a holding section 522 can be more easily distorted than the movable portion 521, and can cause the movable portion 521 to be displaced to the fixed substrate 51 side due to a slight electrostatic attractive force. In this case, because the thickness dimension of the movable portion 521 is greater than the holding section 522 and the rigidity increases, shape changes of the movable portion 521 do not occur even in a case where the holding section 522 is drawn to the fixed substrate 51 side due to the electrostatic attractive force. Accordingly, distortion of the movable reflection film 55 provided on the movable portion 521 does not arise and the fixed reflection film 54 and the movable reflection film 55 can be maintained in the ordinarily parallel state.

It should be noted that although a diaphragm-like holding section 522 is given as an example in the embodiment, there is no limitation thereto and a configuration may be used in which a beam-like holding section arranged at intervals of equal angles with the filter center point as a center.

The region facing the first bonding section 513 on the movable substrate 52 is the second bonding section 523. The second bonding film 532 is provided on the second bonding section 523, and the fixed substrate 51 and the movable substrate 52 are bonded to each other by the second bonding film 532 being bonded to the first bonding film 531 as described above.

### Configuration of Imaging Element of the Imaging Unit

Next, the imaging element 121 of the imaging unit provided in the optical module 10 will be described returning to FIG. 1.

The imaging element 121 receives (detects) light that passes through the variable wavelength interference filter 5, and outputs detection signals to the signal processing circuit 13 based on the amount of light received. It is possible to use various image sensors such as a CCD or CMOS as the imaging element 121. The imaging element 121 includes a plurality of pixels and includes an imaging control driver (not shown) that controls the pixels. The imaging element 121 controls the exposure time in which light is received on each pixel under control from the controller 30, and outputs detection signals to the controller 30 via the signal processing circuit 13 based on the amount of light received in the exposure time.

### Configuration of Signal Processing Circuit, Voltage Controlling Circuit, and Light Source Control Circuit

The signal processing circuit 13 amplifies the detection signal (analog signal) output from the imaging element 121 and outputs the amplified signal to the controller 30 converted to a digital signal. The signal processing circuit 13 is formed by an amplifies that amplifies the detection signals, and an A/D converter that converts analog signals to digital signals, and the like. The signal processing circuit 13 changes the amplification factor of the amplifier under control of the controller 30, amplifies the detection signals by a predetermined amplification factor, and outputs the amplified signal to the controller 30.

The voltage control circuit 14 applies a driving voltage to the electrostatic actuator 56 of the variable wavelength interference filter 5 based on control of the controller 30. Accordingly, the electrostatic attractive force is generated between the fixed electrode 561 and the movable electrode 562 of the electrostatic actuator 56 and the movable portion 521 displaces to the fixed substrate 51 side.

The light source control circuit 15 controls the driving voltage applied to the light source unit 11 and adjusts the amount of light emitted from the light source unit 11. The light source control circuit 15 carries out lighting control of and light amount adjustment of the light source unit 11 at a predetermined timing under control of the controller 30.

### Configuration of Display Unit and Operation Unit

The display unit 21 is formed by various displays such as a liquid crystal display, a plasma display panel (PDP), or an organic EL display panel. The display unit 21 displays a real time image or the like based on control by the controller 30.

The operation unit 22 is formed by various devices able to detect a user operation, such as a mouse, keyboard, or touch panel.

### Configuration of Controller

Next, the controller 30 of the colorimetry device 1 will be described.

The controller 30 is formed by a CPU, a memory, and the like being combined and controls the overall operation of the colorimetry device 1. The controller 30 is provided with a storage unit 31 and a processor 32 as illustrated in FIG. 1.

The storage unit 31 stores various programs and a variety of data for controlling the colorimetry device 1. The data is V-λ data indicating the wavelength of transmitted light with respect to the driving voltage applied to the electrostatic actuator 56 or information (such as colorimetry start wavelength, change interval of the wavelength, and colorimetry finish wavelength) pertaining to the colorimetry wavelength when measuring the measurement object X.

The processor 32 functions as a filter controller 321, a light source controller 322, a light amount acquisition unit 323, an image synthesizer 324, a display controller 325, a colorimetry range detector 326, a color determining unit 327, a colorimetry controller 328 or the like by reading out and executing various programs stored in the storage unit 31, as illustrated in FIG. 1.

It should be noted that although an example is illustrated in the embodiment in which the above various functions are realized by the cooperation of software and hardware by the processor 32 reading out and executing programs (software) recorded in the storage unit 31, there is no limitation thereto. For example, a configuration may be used in which a circuit is provided as hardware that has the respective functions.

The filter controller 321 sets the object wavelength of light extracted by the variable wavelength interference filter 5, and outputs an instruction signal that a driving voltage corresponding to the set object wavelength is applied to the electrostatic actuator 56, based on the V-λ data, to the voltage control circuit 14.

The light source controller 322 controls the light source control circuit 15, causes the driving voltage to be applied to the light source unit 11 at a predetermined timing, such as during colorimetry, and causes the light source unit 11 to be lit up.

The light amount acquisition unit 323 acquires the amount of received light (brightness value) in each pixel of the imaging element 121 based on the detection signal input from the signal processing circuit 13, that is, acquires the imaged image.

The image synthesizer 324 synthesizes a portion of the measurement object X, that is, the imaged image with a plurality of wavelengths imaged by the imaging element 121 of the optical module 10 when an instruction for carrying out the colorimetry process is input by the user, and generates a color image. The image synthesizer 324 uses the imaged image with 3 wavelengths (bands) corresponding to red, green, and blue from the imaged image with 16 wavelengths (bands) used in colorimetry, and synthesizes the color image. It is possible to use red with a wavelength of 610 nm, green with a wavelength of 550 nm and blue with a wavelength of 450 nm as the three wavelengths.

The display controller 325 causes a color image of the measurement object X, colorimetry results by the colorimetry controller 328, described later, and the like to be displayed in the display unit 21.

The colorimetry range detector 326 detects the colorimetry range when the colorimetry range is designated by the operator. Specifically, the operator operates the operation unit 22 and designates the colorimetry range while referencing the color image of the measurement object X displayed on the display unit 21. The color image is divided into a plurality of blocks (image regions) with a predetermined size, as described later. That is, in a case in which a designation instruction operation that designates one block in the color image as the colorimetry range is given by the operator, the colorimetry range detector 326 detects the designated block as the colorimetry range based on the designation instruction. It should be noted that the colorimetry range detector 326 detects the designated position on the color image designated by the operator and may detect the block that includes the designated position as the colorimetry range.

The color determining unit 327 determines whether or not a plurality of colors is included in the colorimetry range. Specifically, in a case where the detection values of the reference pixel and another pixel from the detection values corresponding to the brightness values of each pixel of the imaging element 121 are compared and different colors are included, the color determining unit 327 detects that a plurality of colors is included by detecting these. It should be noted that it is possible to arbitrarily set the reference pixel to a pixel positioned at the center of the colorimetry range, a pixel positioned at a corner position in a case where the colorimetry range is rectangular, and, in the embodiment, a pixel positioned at the center of the colorimetry range is set as the reference pixel.

The color determining unit 327 determines the color of each pixel and counts the number of pixels for each color based on the detection value of each pixel included in the colorimetry range in a case where it is determined that a plurality of colors is included in the colorimetry range.

The details of the color determination method by the color determining unit 327 will be described later.

The colorimetry controller 328 acquires the colorimetry results for reach color included in the colorimetry range based on the amount of received light (brightness value) for each pixel acquired by the light amount acquisition unit 323 and the determination results for the color determining unit 327. The colorimetry controller 328 calculates the reflectivity of each color as an average in the colorimetry range and acquires the spectral spectrum based on the average value of the amount of received light of the pixels determined to be the same color by the color determining unit 327 and the reference amount of received light when a white reference material is imaged. The colorimetry controller 328 calculates the colorimetry results for the colorimetry range using the spectral spectrum.

### Colorimetry Method in Colorimetry Device

Next, an overview of the operation of the colorimetry device 1 as described above will be described below based on the drawings.

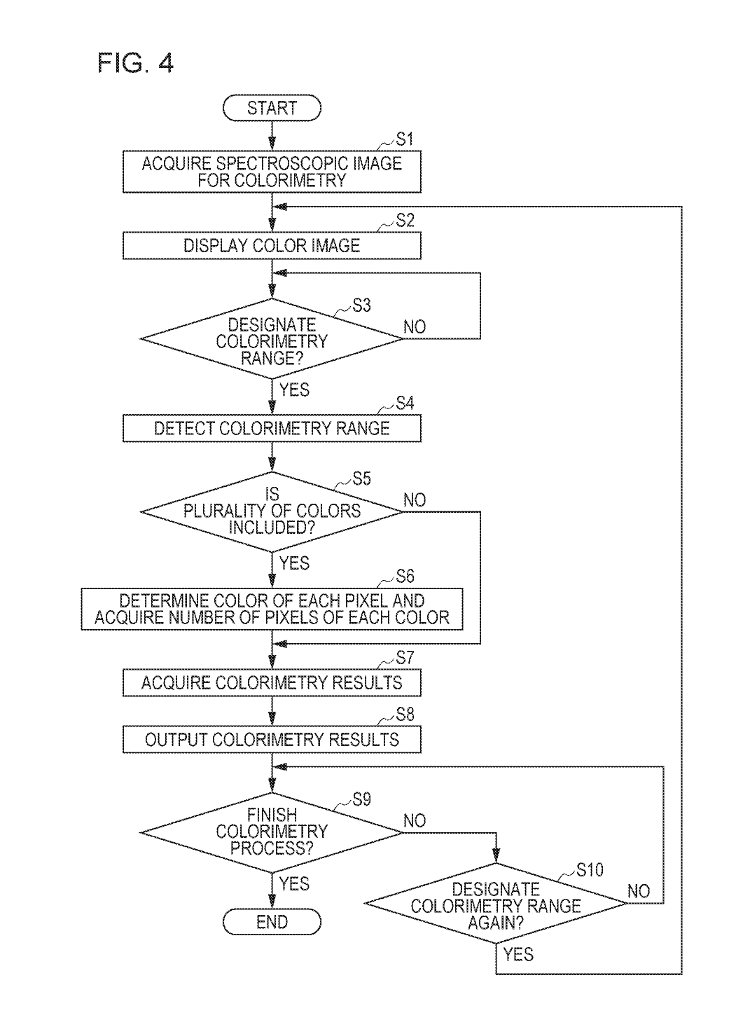

FIG. 4 is a flowchart illustrating the colorimetry method in the embodiment.

### Acquisition of Spectroscopic Image

In the colorimetry device 1 of the embodiment, when a start instruction for the colorimetry process is input by the operation of the operation unit 22 by an operator, as illustrated in FIG. 4, the light source controller 322 causes the light source unit 11 to light up, and thereafter, the filter controller 321 controls the voltage control circuit 14, causes a driving voltage corresponding to the wavelength for each predetermined interval (for example, 20 nm intervals) in the predetermined measurement object wavelength region (for example, visible light region) to be applied sequentially to the electrostatic actuator 56, and acquires a spectroscopic image of each wavelength imaged by the imaging element 121 as the spectroscopic colorimetry results (step S1). For example, in a case of acquiring spectroscopic images at 20 nm intervals with respect to a measurement object wavelength region of 400 nm to 700 nm, spectroscopic images are acquired for 16 wavelengths.

### Generation and Display of Color Image

Next, the image synthesizer 324 synthesizes the color image using the spectroscopic images acquired in step S1, and the display controller 325 causes the synthesized color image to be displayed on the display unit 21 (step S2).

The color image is acquired by synthesizing spectroscopic images with predetermined wavelengths set in advance in the wavelength region of each color of R (for example, 600 to 700 nm), G (for example, 500 to 580 nm), and B (for example, 400 to 480 nm) from the imaged images with 16 bands acquired in step S1, that is, with the three bands corresponding to the colors of R, G, and B.

### Designation of Colorimetry Range

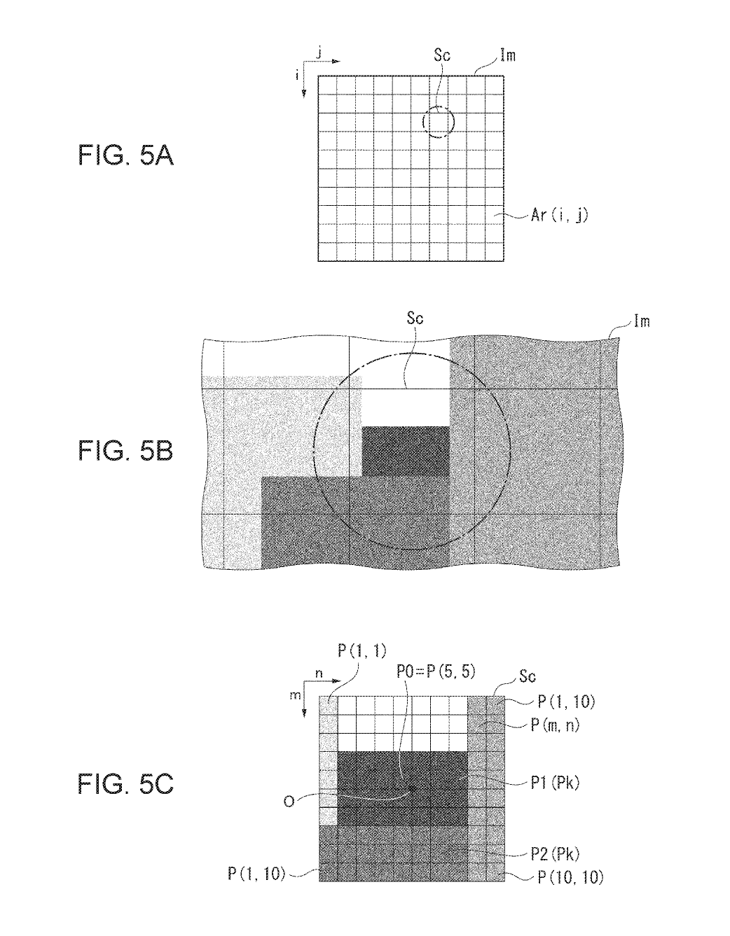

FIGS. 5A to 5C are drawings schematically illustrating a color image. FIG. 5A illustrates a color image corresponding to the entire imaging range of the imaging element 121, FIG. 5B illustrates an enlargement of a portion that includes the colorimetry range in the color image, and FIG. 5C illustrates an enlargement of one block in the color image.

The color image Im displayed on the display unit 21 is divided into a plurality of blocks Ar (i, j) (i signifies the column number of the block, j signifies the row number of the block), as illustrated in FIG. 5A. In the embodiment, the imaged image is divided into 100 blocks, as an example (refer to FIG. 5A). Each block includes a plurality of pixels, and each pixel corresponds to one pixel that forms the imaging element 121. In the embodiment, each block is formed by 100 pixels, as an example (refer to FIG. 5C).

It should be noted that the boundary lines of the blocks may or may not be displayed on the display unit 21.

As illustrated in FIG. 4, when the color image Im is displayed on the display unit 21 in step S2, the colorimetry range detector 326 determines whether the designation operation of the colorimetry range Sc is carried out by the operator (step S3). That is, when the operator carries out the designation operation that designates a desired block in the color image Im as the colorimetry range Sc (refer to FIGS. 5A to 5C), the colorimetry range detector 326 detects that the designation operation is carried out (step S3: Yes). The determination process in step S3 is repeatedly executed until the designation instruction of the colorimetry range Sc is carried out by the operator and “Yes” is determined in step S3.

When “Yes” is determined in step S3, the colorimetry range detector 326 detects the colorimetry range Sc based on the designation operation (step S4). That is, the colorimetry range detector 326 detects the colorimetry range Sc by detecting if the block designated as the colorimetry range Sc from all of the blocks Ar (i, j) included in the color image Im is any of the blocks. FIG. 5A illustrates an example where the block Ar (3, 7) is designated as the colorimetry range Sc.

When the colorimetry position is designated by the user in a case where the boundary lines of the blocks is not displayed on the display unit 21, the colorimetry range detector 326 detects the designation instruction of the colorimetry position and detects the block that includes the designated position as the colorimetry range.

### Determination of Number of Colors in Colorimetry Range

Next, as illustrated in FIG. 4, the color determining unit 327 determines whether a pixel corresponding to a different color is included as a pixel that forms the colorimetry range Sc, that is, whether a plurality of colors is included in the colorimetry range Sc (step S5).

For example, as illustrated in FIGS. 5B and 5C, in a case where pixels corresponding to a plurality of colors is included in the colorimetry range Sc, the color determining unit 327 determines that a plurality of colors is included in the colorimetry range Sc (step S5: Yes).

Meanwhile, in a case where all the pixels are pixels corresponding to the same color, the color determining unit 327 determines that a plurality of colors is not included in the colorimetry range Sc (steps S5: No).

Below, an example of the method of determining whether a plurality of colors is included in the colorimetry range Sc will be described.

The color determining unit 327 uses the brightness values of a predetermined plurality of bands (predetermined plurality of wavelengths) from the data of brightness values of the 16 bands of each pixel, and determines whether the reference pixel P0 (first pixel) and the comparison pixel Pk (second pixel) are pixels corresponding to the same color. For example, the color determining unit 327 determines whether the reference pixel P0 and the comparison pixel Pk are pixels corresponding to different colors based on the brightness value of the reference pixel P0 in the spectroscopic image with a predetermined first wavelength and the brightness value of the comparison pixel Pk, and the brightness value of the reference pixel P0 in the spectroscopic image with a predetermined second wavelength and the brightness value of the comparison pixel Pk. More specifically, the color determining unit 327 determines that the respective pixels P0 and Pk are pixels corresponding to the same color in a case where the difference in the respective brightness values of the band (wavelength) that is the comparison object is within a threshold at the reference pixel P0 and comparison pixel Pk. Meanwhile, the color determining unit 327 determines that the reference pixel P0 and the comparison pixel Pk are pixels corresponding to different colors in a case where the reference pixel P0 and the comparison pixel Pk are compared and a band that exceeds the threshold is present.

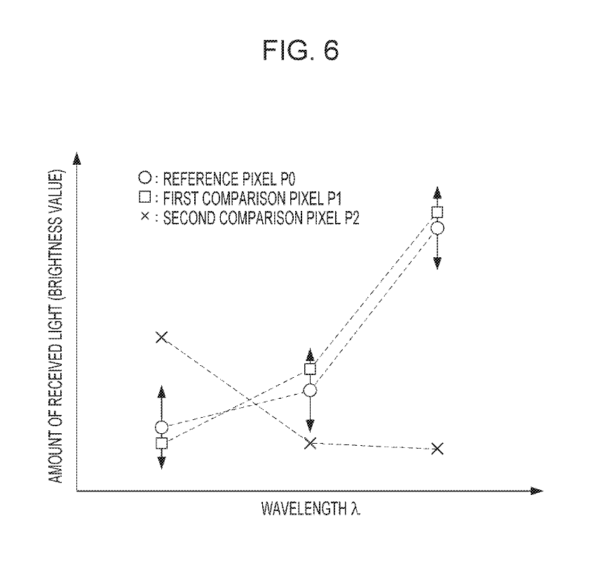

FIG. 6 is a drawing for specifically illustrating an example of the method for determining with the color determining unit 327 whether the reference pixel P0 and another pixel correspond to the same color. In the following description, in a case of denoting each pixel that forms the colorimetry range Sc as pixel P (m, n), m signifies the row number of the pixel and n signifies the column number of the pixel.

In the embodiment, three bands corresponding to each of the three colors of R, G, and B are used as the predetermined band of the comparison object. The reference pixel P0 is set to a pixel positioned in the center portion of the colorimetry range Sc, for example, including or adjacent to the center point O (in the embodiment, P (5, 5) is given as an example) (refer to FIG. 5C).

As illustrated in FIG. 6, in the first comparison pixel P1 (refer to FIG. 5C) corresponding to the same color as the reference pixel P0, the brightness value of each band is a value within the predetermined range with the brightness value of the reference pixel P0 as a reference. That is, the difference value between the brightness values of the reference pixel P0 and the first comparison pixel P1 is within the threshold for each of all the bands of the measuring object.

Meanwhile, in the second comparison pixel P2 (refer to FIG. 5C) corresponding to a different color to the reference pixel P0, the brightness value of each band is a value outside the predetermined range with the brightness value of the reference pixel P0 as a reference.

In this way, the color determining unit 327 compares the brightness value of each band of the comparison object for the reference pixel P0 and the comparison pixel Pk and determines that the reference pixel P0 and the comparison pixel Pk are pixels corresponding to the same color if the difference value of the brightness values is within the threshold for all bands. Meanwhile, in a case where at least one band exceeds the threshold, the color determining unit 327 determines that the reference pixel P0 and the comparison pixel Pk are pixels corresponding to different colors.

It should be noted that the number of bands of the comparison object is not limited to the embodiment, and four or more (for example, all 16 bands) may be used, or one or two bands may be used as long as determination of the color is possible.

In step S5, the color determining unit 327 changes the comparison pixel Pk and carries out the comparison process between the reference pixel P0 and the comparison pixel Pk until a comparison pixel Pk corresponding to a different color to the reference pixel P0 is detected or the comparison process is finished for all pixels.

The color determining unit 327 sequentially selects the furthest pixel from the center point O from the pixels for which the comparison process is not completed as the comparison pixel Pk. That is, the comparison pixel Pk such as the respective pixels P (1, 1), P (1, 10), P (10, 10), and P (10, 1) of the four corners of the colorimetry range are sequentially selected as the comparison pixel Pk. In this way, it is possible to achieve a reduction in the number of comparison processes until a different color being included in the colorimetry range Sc is detected and to achieve a reduction in the processing load by selecting a comparison pixel Pk from pixels on the periphery of the reference pixel P0, that is, from pixels other than those with a high possibility of normally being the same color as the reference pixel P0.

The method of selecting the comparison pixel Pk is not limited to the above-described method and for example, the furthest pixel from the comparison pixel Pk-1 during the k-1th comparison process from the pixels for which the comparison process is not completed and that are furthest from the center point O may be selected as the comparison pixel Pk when the k-th comparison process is carried out (when selecting the comparison pixel Pk). For example, the comparison pixels Pk are selected in the order of pixel P (1, 1), P (10, 10), P (1, 10), and P (10, 1). In this case, it is possible to select the comparison pixel Pk from pixels other than those with a high possibility of being the same color as the comparison pixel Pk-1 and it is possible to achieve a reduction in the processing load due to the comparison process as described above.

When newly selecting a comparison pixel Pk, a pixel which is adjacent to a pixel for which the comparison process is complete and a pixel with a high possibility of being the same color as the pixel for which the comparison process is complete may be excluded from the comparison object. That is, a pixel separated from the pixel for which the comparison process is complete may be selected as the comparison pixel Pk. More specifically, the pixels included in the predetermined range with the pixel for which comparison is complete as a center are excluded from the comparison object, and the comparison pixel Pk may be selected from the other pixels. In this case, it is similarly possible to reduce the processing load due to the comparison process.

### Color Determination of Each Pixel

Returning to FIG. 4, in a case where it is determined that a plurality of colors is included in the colorimetry range Sc in step S5 (step S5: Yes), next, the color determining unit 327 determines the color of each pixel P (m, n) and counts the number of pixels of each color (step S6).

The color determination of each pixel P (m, n) is carried out by storing the pattern of brightness values for the 16 bands for the color of the determination object in the storage unit 31 and the color determining unit 327 comparing the pattern and the brightness values of the 16 bands for each pixel P (m, n), determining the color of each pixel P (m, n), and counting the number of pixels for each color. It should be noted that the number of bands used in the color determination is not limited to 16 bands, and, as long as determination of the color is possible, an arbitrary number of bands may be used, for example, the three bands R, G, and B may be used.

For example, the pixel for which the color is determined is made the color reference pixel Pc, and the color determining unit 327 carries out determining whether the color is the same as described above for the color reference pixel Pc and another pixel, and counts the number of pixels determined to be the same color. The color determining unit 327 carries out the same process on only the pixel determined to be a different color. The determination process of whether the color reference pixel Pc and another pixel are the same color and the counting of the number of pixels are repeated until the color is determined for all pixels P (m, n) in this way.

In a case where the pixel determined to be a different color does not correspond to the results for the color determination or any of the colors that become the determination object, there is a possibility of the brightness value of the pixel including noise. Therefore, it is possible to calculate the colorimetry results, described later, without using the brightness value of a pixel to which a flag is attached, and possible for the colorimetry precision to be improved by attaching a flag indicating not belonging to any of the colors to the pixel.

### Calculation and Display of Colorimetry Results for Each Color

Next, the colorimetry controller 328 acquires the colorimetry results by calculating the colorimetry value of each color as an average value (step S7).

That is, the colorimetry controller 328 calculates the average value of the brightness values for each of the bands based on the brightness values of the pixels determined to be the same color in step S6. The colorimetry controller 328 calculates the spectral spectrum by calculating the reflectivity in each band based on the average value of the brightness values and the brightness value during imaging of the white reference. The colorimetry controller 328 acquires the spectral spectrum as described above for each color determined to be included in the colorimetry range Sc. The colorimetry controller 328 calculates the colorimetry value using the spectral spectrum of each color. The colorimetry value is calculated based on various expression methods such as the L*a*b* color system or an XYZ color system.

The colorimetry controller 328 calculates the occupancy ratio of each color in the colorimetry range using the counting results for the number of pixels of each color, in addition to the colorimetry value of each color.

Meanwhile, in a case of No in step S5, that is, where it is determined that all of the pixels P (m, n) are the same color and a plurality of colors is not included, step S7 is carried out without carrying out step S6 and calculates the colorimetry value as an average value of all pixels. In this way, it is possible to omit the process of step S6 that determines the color of each pixel in a case of only the same color and it is to suppress the processing load by determining whether a different color is included in the step S5.

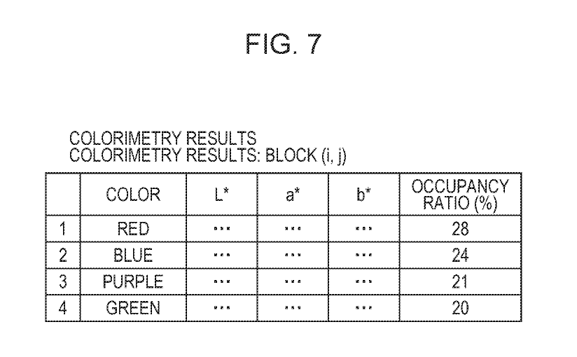

FIG. 7 illustrates a display example of the colorimetry results on the display unit 21.

The display controller 325 causes the colorimetry results to be displayed on the display unit 21 as illustrated in FIG. 7 (step S8).

The display controller 325 causes the colorimetry values of each color calculated by the colorimetry controller 328 to be displayed in order of increasing occupancy ratio. The display controller 325 causes information pertaining to the position of the colorimetry range Sc and information pertaining to date and time of colorimetry, in addition to the colorimetry value and the occupancy ratio, to be displayed on the display unit 21. In the example illustrated in FIG. 7, although only the colorimetry results for a color in which the occupancy ratio is the predetermined value (for example, 10%) or more are displayed, all colors may be displayed.

The controller 30 determines whether an instruction to finish the colorimetry process is received (step S9) and in case where the instruction to finish the colorimetry process is not received (step S9: No), it is determined whether an instruction designating the colorimetry range again is received (step S10). In a case where a re-designation instruction is not received (step S10: No), the controller 30 carries out the process in step S9, and steps S9 and S10 are repeated until the finish instruction or the re-designation instruction for the colorimetry range is received. When the re-designation instruction for the colorimetry range is received (step S10: Yes), the controller 30 carries out the processes subsequent to step S2, and when the finish instruction is received (step S9: Yes), the colorimetry process is finished.

In a case where the imaging range in the measurement object X changes, once the process according to the flowchart is finished, a spectroscopic image as disclosed in step S1 is acquired for a new imaging range, and the process according to the flowchart is carried out.

### Actions and Effects of First Embodiment

The colorimetry device 1 acquires the colorimetry results for each color in a case where a plurality of colors is included in the colorimetry range Sc when acquiring the colorimetry results for the colorimetry range Sc in the spectroscopic images with a plurality of wavelengths imaged by the imaging unit 12. More specifically, the color determining unit 327 determines the color of each pixel of the colorimetry range Sc, and the colorimetry controller 328 acquires the colorimetry results for each color based on the determination results. In such a configuration, it is possible to acquire the colorimetry results for each color with high precision, as described above, even in a case where a plurality of colors is included in the colorimetry range Sc. That is, it is possible to obtain high precision colorimetry results compared to the related art that estimates the spectral spectrum based on an average value of the brightness values (amount of received light) of all pixels with all of the pixels in the colorimetry range Sc as the same color, without discriminating each color regardless of whether a plurality of colors is included in the colorimetry range Sc.

The color determining unit 327 determines the color of each pixel of the colorimetry range Sc, and the colorimetry controller 328 acquires the colorimetry results for each color based on the determination results. In such a configuration, it is possible to acquire the colorimetry results for each color with high precision using the spectroscopic measurement results according to each color, as described above, even in a case where a plurality of colors is included in the colorimetry range Sc.

The color determining unit 327 uses the brightness values of each pixel in the spectroscopic images with predetermined wavelengths (for example, three wavelengths corresponding to three colors, such as red, green, and blue) in the colorimetry range Sc, and determines the number of colors in the colorimetry range Sc. Accordingly, it is possible to easily determine whether a plurality of colors is included, compared to a case of comparing the color by calculating the colorimetry value (such as chromaticity or color difference) of each pixel. An increase in the processing load due to determining whether or not a plurality of colors is included can be suppressed.

The color determining unit 327 determines whether a plurality of colors is included based on the difference in the brightness values between the reference pixel P0 and the comparison pixel Pk. In this way, it is possible to determine whether or not the color of the pixels included in the colorimetry range Sc are the same, and to determine whether a plurality of colors is included in the colorimetry range Sc by using the difference in the brightness values between the reference pixel P0 and the comparison pixel Pk. It is possible to suppress an increase in the processing load due to the determining whether or not a plurality of colors is included compared to a case of calculating the colorimetry results such as the colorimetry value (such as chromaticity or color difference) or the spectral spectrum for all of the comparison pixels Pk and comparing the calculated colorimetry results.

The color determining unit 327 determines that the colors of the reference pixel P0 and the comparison pixel Pk are different in a case where a pixel included in the colorimetry range Sc is used as the reference pixel P0, and the difference between the reference pixel P0 and the comparison pixel Pk exceeds a threshold. In this way, it is possible to easily determine whether the color is the same between the reference pixel P0 and the comparison pixel Pk by calculating the difference in the brightness values between the reference pixel P0 and the comparison pixel Pk and comparing the result to a threshold.

It is possible for the color determining unit 327 to perform determination that a plurality of colors is included in the colorimetry range Sc at the point in time where determining whether the color of the reference pixel P0 and the comparison pixel Pk is the same is carried out and a comparison pixel Pk is present that is determined to be different.

In the embodiment, because the color determining unit 327 acquires the colorimetry results without carrying out the color determination for each pixel in a case where all pixels are determined to be the same color by carrying out the color determination, it is not necessary to carry out the color determination in a case where all pixels are the same color and it is possible to lower the processing load.

The colorimetry controller 328 acquires the colorimetry results based on the average value of each wavelength in the plurality of pixels for the color in which a plurality of pixels determined to be the same color are included in the colorimetry range based on the determination results. Accordingly, it is possible to suppress the influence of noise and to acquire colorimetry results with greater precision compared to a case where the colorimetry results are acquired for each pixel.

The display controller 325 synthesizes the spectroscopic images with a plurality of wavelengths, thereby generating a color image, and causes the color image to be displayed. It is possible to carry out a process such as the colorimetry range being selected and for the operability to be improved while the color image is referenced by a user.

The color determining unit 327 determines the color of each pixel included in the colorimetry range Sc, acquires the colorimetry results for each color based on the determination results, and outputs the colorimetry results in response to the occupancy ratio. In this way, it is possible for the user to verify not only the colorimetry results for each color but also the occupancy ratio of colors forming the colorimetry range as the colorimetry results for the colorimetry range Sc. It is possible for the user to easily ascertain the colorimetry results.

### Second Embodiment

Next, the second embodiment according to the invention will be described.

In the embodiment, a color image in which spectroscopic images with three bands are synthesized after spectroscopic images for colorimetry with 16 bands is captured is displayed on the display unit 21, the colorimetry range designated by an operator while referencing the color image is detected, and colorimetry of the colorimetry range is carried out. In contrast, in the second embodiment, a color image is acquired as a real time image and is displayed on the display unit 21, the colorimetry range designated by the operator while referencing the color image is detected, spectroscopic images for colorimetry with 16 bands are imaged for the colorimetry range, and colorimetry of the colorimetry range is carried out.

It should be noted that in the following description, the same configurations as the first embodiment are given the same reference numerals and description thereof will be omitted or simplified.

### Colorimetry Method in Colorimetry Device

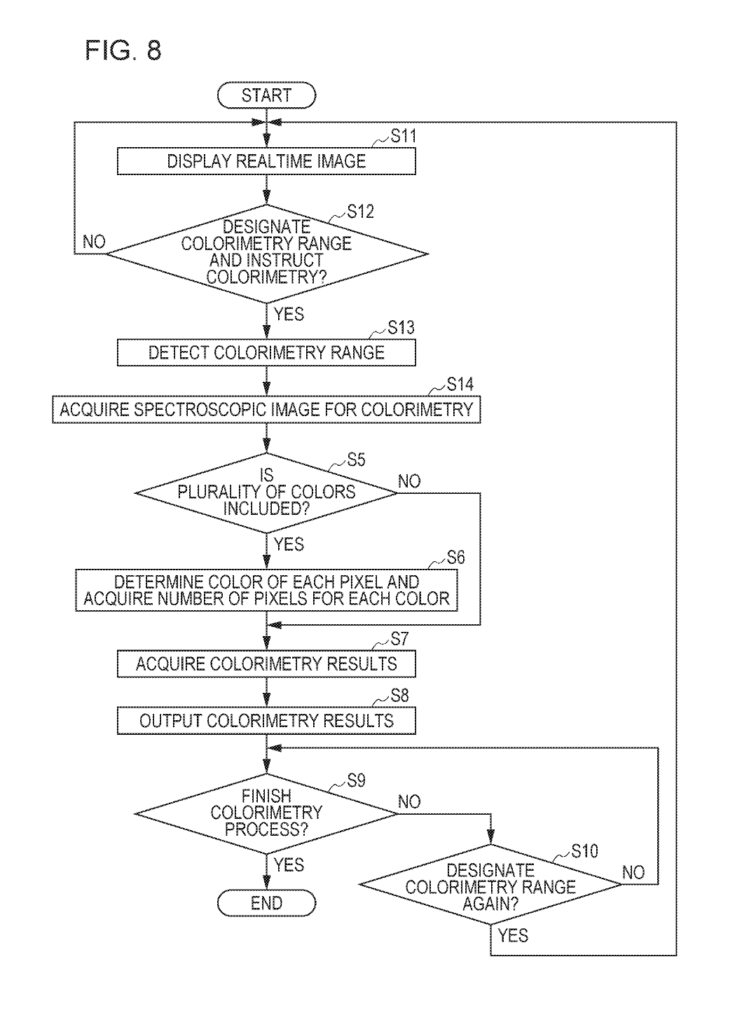

FIG. 8 is a flowchart illustrating the colorimetry method in the embodiment.

When the start instruction for the spectroscopy is input according to the operation of the operation unit 22 by the operator, the colorimetry device 1 of the embodiment generates a real time image as a color image after the light source unit 11 is caused to light up, and causes the image to be displayed on the display unit 21 (step S11).

The real time image is obtained by acquiring spectroscopic images (spectroscopic images for synthesized image generation) with predetermined wavelengths set in advance in the wavelength regions of each of the colors of R (for example, 600 to 700 nm), G (for example, 500 to 580 nm), and B (for example, 400 to 480 nm), that is, three predetermined wavelengths corresponding to each of the colors of R, G, and B (three bands), and synthesizing these spectroscopic images.

Specifically, the filter controller 321 controls the voltage control circuit 14 and causes driving voltages corresponding to the three predetermined wavelengths to be sequentially applied to the electrostatic actuator 56. Accordingly, spectroscopic images corresponding to these wavelengths are sequentially obtained by the three predetermined wavelengths of light passing through the variable wavelength interference filter 5 in order and being detected (captured) by the imaging element 121.

The image synthesizer 324 synthesizes the spectroscopic images for generating the synthesized image with the three bands, thereby generating the synthesized image. Thereafter, the display controller 325 causes the generated synthesized image to be displayed in the display unit 21.

Thereafter, the operator designates the position at which colorimetry is performed (designated position) while referencing the real time image that is displayed according to step S11. The controller 30 determines whether a colorimetry range designation instruction and a colorimetry instruction are received according to the operation of the operation unit 22 by the operator (step S12).

In a case where “No” is determined according to step S12, step S11 is continued, and a real time image is displayed on the display unit 21.

In a case where “Yes” is determined in step S12, the colorimetry range detector 326 detects the colorimetry range (step S13).

Specifically, the operator operates the operation unit 22 and designated the desired block Ar (i, j) in the color image divided into a plurality of blocks as the colorimetry range Sc while referencing the real time image of the measurement object X displayed on the display unit 21, similarly to the first embodiment. The colorimetry range detector 326 detects the colorimetry range Sc and detects the position of the pixel of the imaging element 121 corresponding to the colorimetry range by detecting the position of the designated block Ar (i, j). Accordingly, it is possible to detect the position of the colorimetry range Sc in the imaged image with 16 bands acquired later.

Next, the controller 30 acquires spectroscopic images with 16 bands as the spectroscopic images for colorimetry (step S14).

Specifically, the filter controller 321 controls the voltage control circuit 14, causes the driving voltage corresponding to the plurality of measurement object wavelengths to be sequentially applied to the electrostatic actuator 56, and acquires the spectroscopic image with each wavelength imaged by the imaging element 121.

In this case, only the detection signal from the pixel corresponding to the colorimetry range Sc (refer to FIGS. 5A to 5C) in the imaging element 121 is acquired and the spectroscopic image corresponding to the colorimetry range Sc is acquired. Accordingly, it is possible for the data amount of the spectroscopic images to be reduced and increases in the processing load to be suppressed compared to a case of acquiring a spectroscopic image corresponding to the entire imaging range.

It should be noted that the spectroscopic image corresponding to the entire imaged region (refer to FIG. 5A) may be acquired. Accordingly, even if the colorimetry range is changed with a block selected from the plurality of blocks included in the imaging range as the new colorimetry range after the spectroscopic image is imaged, the spectroscopic image need not be re-acquired, and it is possible to shorten the processing time.

When the spectroscopic image for colorimetry is acquired in step S14, next, the processes in steps S5 to S10 are carried out, similarly to the first embodiment. That is the color determining unit 327 determines whether or not a plurality of colors is included in the colorimetry range Sc (step S5). When “Yes” is determined in step S5, the color determining unit 327 acquires the color of each pixel P (m, n) in the colorimetry range Sc and the number of pixels of each color (step S6) and calculates the colorimetry value for each color (step S7). Meanwhile, when “No” is determined in step S5, the colorimetry value is calculated without carrying out step S6 (step S7). The display controller 325 causes the colorimetry results to be displayed on the display unit 21 (step S8). Next, the controller 30 determines whether an instruction to finish the colorimetry process is received (step S9), and determines whether a re-designation instruction for the colorimetry range Sc is received in a case where “No” is determined in step S9 (step S10). When “Yes” is determined in step S10, the controller 30 returns to step S11, and carries out the subsequent processes. The controller 30 repeats the determination in steps S9 and S10 until a finish instruction for the colorimetry process or a re-designation instruction for the colorimetry range Sc is detected.

### Actions and Effects of Second Embodiment

According to the colorimetry method of the second embodiment, it is possible to obtain the following actions and effects, in addition to the same actions and effects as the first embodiment.

In the second embodiment, the colorimetry device 1 acquires spectroscopic images with three bands, causes the display unit 21 to display a real time image from the spectroscopic images with three bands, and allows the user to designate the colorimetry range. When the colorimetry device 1 detects that the colorimetry range is designated and a colorimetry instruction is received, the colorimetry device 1 detects the colorimetry range Sc. In such a configuration, the colorimetry device 1 acquires the spectroscopic image with only the range corresponding to the colorimetry range Sc when acquiring the spectroscopic images for colorimetry with 16 bands. That is, it is possible to acquire the detection signal from the pixels of the imaging element 121 corresponding to the colorimetry range Sc, and to acquire the spectroscopic images. Accordingly, it is possible to better reduce the data amount of the spectroscopic images than in a case of acquiring a spectroscopic image in the entire imaging range for each of the 16 bands.

### Third Embodiment

Next, the third embodiment according to the invention will be described.

In the third embodiment, a printer 60 (ink jet printer) that is provided with the colorimetry device 1 of the first or second embodiment and that corresponds to the printing apparatus of the invention will be described.

### Schematic Configuration of Printer

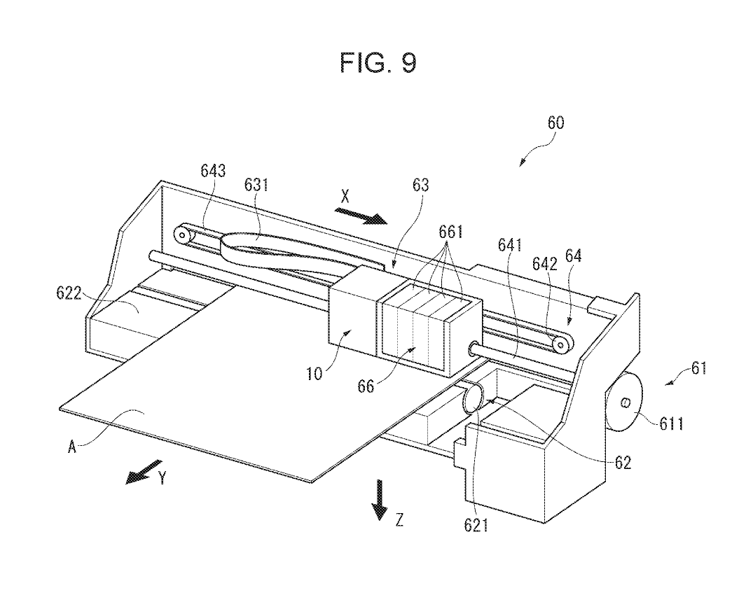

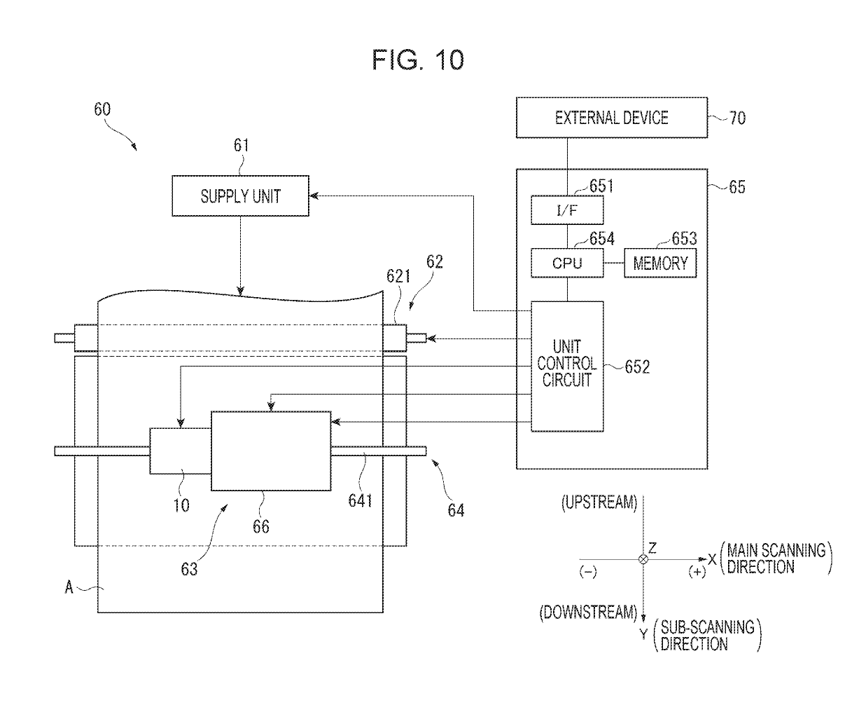

FIG. 9 is a drawing illustrating a schematic configuration of the printer 60 of the third embodiment. FIG. 10 is a block diagram illustrating a schematic configuration of the printer 60 of the embodiment.

As illustrated in FIG. 9, the printer 60 is provided with a supply unit 61, a transport unit 62, a carriage 63, a carriage movement unit 64, and a control unit 65 (refer to FIG. 10). The printer 60 controls each unit 61, and 64, and the carriage 63 and prints an image on a medium A based on printing data input from an external device, such as a personal computer.

### Configuration of Supply Unit

The supply unit 61 is a unit that supplies a medium A (in the embodiment, a white sheet surface is given as an example) that is an image formation object to an image forming position. The supply unit 61 is provided with a roll member 611 on which the medium A is wound, a roll driving motor (not shown) and a roll drive wheel train (not shown) and the like. The roll driving motor is driven to rotate based on instructions from the control unit 65, and rotational power of the roll driving motor is transmitted to the roll member 611 via the roll drive wheel train. Accordingly, the roll member 611 rotates, and the sheet surface wound on the roll member 611 is supplied to the downstream side (+Y direction) in the Y direction (sub-scanning direction).

It should be noted that although and example in which the sheet surface wound on the roll member 611 is supplied is illustrated in the embodiment, there is no limitation thereto. For example, the medium A may be supplied by any supply method, such as supplying the media A, such a sheet surface stacked on a tray or the like one at a time with a roller or the like.

The transport unit 62 transports the medium A supplied from the supply unit 61 along the Y direction. The transport unit 62 is formed including a transport roller 621, a driven roller (not shown) that is arranged interposing a medium A with the transport roller 621 and that is driven by the transport roller 621, and a platen 622.

When the driving power is transmitted from the transport motor, not shown, and the transport motor is driven according to the control of the control unit 65, the transport roller 621 is driven to rotate by the rotational power and transports the medium A along the Y direction in a state where pinched with the driven roller. A platen 622 that faces the carriage 63 is provided on the downstream side (+Y side) in the Y direction of the transport roller 621.

### Configuration of Carriage

The carriage 63 is provided with an optical module that acquires a spectroscopic image for performing colorimetry of a measurement object printed on the medium A and a printing unit 66 that prints an image on the medium A.

The carriage 63 is provided to be movable along the main scanning direction (X direction) that intersects the Y direction by a carriage movement unit 64.

The carriage 63 is connected to the control unit 65 (refer to FIG. 9) by the flexible circuit 631, and carries out the printing process with the printing unit 66 (image forming process with respect to the medium A) and the colorimetry process with the optical module 10 (refer to the first and second embodiments) based on instruction from the control unit 65.

The printing unit 66 is the image-forming unit of the embodiment and individually discharges ink on the medium A at a part that faces the medium A and forms an image on the medium A.

The printing unit 66 has ink cartridges 661 corresponding to a plurality of colors of ink that are mounted to be freely detachable, and the ink is supplied via a tube (not shown) from each ink cartridge 661 to an ink tank (not shown). Nozzles (not shown) that discharge ink droplets are provided in the lower surface (position facing the medium A) of the printing unit 66 corresponding to each color. A piezoelectric element is arranged in the nozzle, and an ink droplet supplied from the ink tank is discharged by the piezoelectric element being driven and lands on the medium A, thereby forming a dot.

### Configuration of Carriage Movement Unit

The carriage movement unit 64 forms a movement mechanism in the invention, and causes the carriage 63 to reciprocate along the X direction based on instructions from the control unit 65.

The carriage movement unit 64 is formed including a carriage guide shaft 641, a carriage motor 642, and a timing belt 643.

The carriage guide shaft 641 is arranged along the X direction, and both end portions are fixed to the housing of the printer 60. The carriage motor 642 causes the timing belt 643 to be driven. The timing belt 643 is supported to be substantially parallel to the carriage guide shaft 641, and is fixed to one portion of the carriage 63. When the carriage motor 642 is driven based on the instructions of the control unit 65, the timing belt 643 is run forward, and the carriage 63 fixed to the timing belt 643 reciprocates guided on the carriage guide shaft 641.

### Configuration of Control Unit

The control unit 65 is formed including an I/F 651, a unit control circuit 652, a memory 653, and a central processing unit (CPU) 654, as illustrated in FIG. 10. The control unit 65 is formed to be able to realize the same function as the controller 30 in the first and second embodiments.

The I/F 651 inputs printing data input from the external device 70 to the CPU 654.

The unit control circuit 652 is provided with a control circuit that controls each of the optical module 10, the supply unit 61, the transport unit 62, the carriage movement unit 64, and the printing unit 66, and controls the operation of the optical module 10, the printing unit 66, and each unit 61, 62, and 64 based on the instruction signal from the CPU 654. That is, the colorimetry device of the invention is formed including the optical module 10 and the control unit 65. The signal processing circuit 13, the voltage control circuit 14, and the light source control circuit 15 that are illustrated in FIG. 1 may be provided in the unit control circuit 652. In this case, the light source unit 11 and the imaging unit 12 from the optical module 10 are provided in the carriage 63.

The memory 653 stores various programs and a variety of data that control the operation of the printer 60.

Examples of the variety of data include V-λ data that indicates the wavelength of light that passes through the variable wavelength interference filter 5 with respect to the voltage applied to the electrostatic actuator 56 when controlling the variable wavelength interference filter 5, and printing profile data that stores the discharge amount of each ink with respect to the color data included in the print data. The light generating characteristics (light generation spectrum) with respect to each wavelength of the light source unit 11 (refer to FIG. 1), the light receiving characteristics (light receiving sensitivity characteristics) with respect to each wavelength of the imaging element 121 (refer to FIG. 1), and the like may be stored.

### Actions and Effects of Third Embodiment

The printer 60 of the embodiment is provided with the optical module 10, and is formed to be able to acquire the spectroscopic image of an image printed on the medium A and carry out the colorimetry process using the spectroscopic image. In such a configuration, it is possible to carry out colorimetry of an image with high precision, and to acquire the colorimetry results for an image printed on the medium A by the printing unit with high precision, similarly to the first and second embodiment.

### Modification of Embodiment

It should be noted that the invention is not limited to the above-described embodiments, and configuration obtained according to modifications, improvements, combinations, as appropriate, of the embodiments within a scope capable of achieving the advantages of the invention are also included invention.

In each of the embodiments, although it is determined that a different color is included in the colorimetry range when a pixel corresponding to a different color to the reference pixel is detected in the colorimetry range, the invention is not limited thereto. Even in a case where a pixel corresponding to a different color to the reference pixel is included in the colorimetry range, it may be determined that a different color is not included in the colorimetry range (steps S5: No) in a case where the occupancy ratio of the pixel determined to be a different color is within a predetermined threshold, and step S7 may be carried out without carrying out step S6. The predetermined threshold is set so that the colorimetry results in which all pixels are acquired as the same color reach an acceptable colorimetry precision. Accordingly, all pixels are determined to be the same in a case where the occupancy ratio of the pixel corresponding to the different color is within the predetermined threshold. Therefore, it is possible to acquire the colorimetry results without carrying out color determination for each pixel, and to suppress the processing load of the colorimetry process.

Although a pixel in the center of the colorimetry range is selected as the reference pixel in each of the above-described embodiments, the invention is not limited thereto and a pixel outside the colorimetry range may be selected as the reference pixel. In this case, the difference value in the brightness values of the reference pixel and each comparison pixel in the colorimetry range are each acquired, and whether a pixel with a different color is included in the colorimetry range is determined based on the difference value of each comparison pixel. More specifically, a pixel for which the color is known is selected as the reference pixel, the difference value with two comparison pixels is compared, and it is possible to determine that the colors of the two comparison pixels differ in a case where the difference exceeds a threshold.

Although determination of the number of colors is carried out and color determination is carried out in a case where it is determined that a plurality of colors is included in the colorimetry range Sc in the embodiment, the invention is not limited thereto. For example, color determination may be carried out for each pixels, and determination of the number of colors in the colorimetry range Sc, that is, of whether a plurality of colors is included in the colorimetry range may be carried out based on the results of carrying out the color determination.

Although an example is given in each of the embodiments of a configuration that acquires the spectral spectrum of each color, and thereafter calculates the colorimetry value as a numerical value by calculating an average value of the brightness values of pixels determined to be the same color, the invention is not limited thereto. For example, the colorimetry results may be acquired by acquiring the spectral spectrum using the brightness value of 16 bands on a per pixel basis, and carrying out determining whether the colors are the same with reference to the colorimetry value of each pixel after the colorimetry value is calculated from the spectral spectrum, and calculating the average value of the colorimetry values of pixels determined to have the same color.

Although the colorimetry value for each pixel is calculated as the colorimetry results in each of the embodiments, the invention is not limited thereto. For example, the spectral spectrum for each color may be acquired as the colorimetry results without calculating the colorimetry value.

In each embodiment, although an example is provided where the variable wavelength interference filter 5 in which the fixed substrate 51 and the movable substrate 52 are bonded in a state where facing one another and the fixed reflection film 54 is provided on the fixed substrate 51 and the movable reflection film 55 is provided on the movable substrate 52 as a spectroscopy element, there is no limitation thereto.

For example, a configuration in which the fixed substrate 51 and the movable substrate 52 are not bonded, and a gap changing unit that changes the gap between reflection films, such as a piezoelectric element is provided between the substrates may be used.

There is no limitation to a configuration formed by two substrates. For example, a variable wavelength interference filter may be used in which two reflection films are stacked on one substrate with a sacrificial layer interposed and a gap is formed by removing the sacrificial layer by etching or the like.

An acoustic optic tunable filter (AOTF) or a liquid crystal tunable filter (LCTF) may be used as the spectral filter. However, it is preferable to use a Fabry-Perot filter as in the embodiments from the viewpoint of size reductions in the device.

Additionally, specific structures when carrying out the invention may be formed by combining, as appropriate, the embodiments and modification examples within a scope able to achieve the advantages of the invention, and or other structures and the like may be changed, as appropriate.

The entire disclosure of Japanese Patent Application No. 2015-173663, filed Sep. 3, 2015 is expressly incorporated by reference herein.

What is claimed is:

1. A colorimetry method, comprising:
acquiring spectroscopic measurement results for a colorimetry range in an image; and
acquiring colorimetry results for a first color based on the spectroscopic measurement results for the first color from a plurality of colors, in a case where the plurality of colors is included in the colorimetry range.

2. The colorimetry method according to claim 1, further comprising:
determining whether or not the plurality of colors is included in the colorimetry range.

3. The colorimetry method according to claim 2,
wherein in the acquiring of the spectroscopic measurement results, spectroscopic images with a plurality of wavelengths for the colorimetry range is acquired, and
in the determining, whether or not a plurality of colors is included based on a brightness value of each pixel of a spectroscopic image with a predetermined wavelength from the spectroscopic images with a plurality of wavelengths for the colorimetry range is determined.

4. The colorimetry method according to claim 3,
wherein in the determining, whether or not a plurality of colors is included based on a difference in the brightness values between a reference pixel and a comparison pixel included in the colorimetry range for the spectroscopic image with a predetermined wavelength is determined.

5. The colorimetry method according to claim 4,
wherein the reference pixel is a pixel included in the colorimetry range, and
in the determining, it is determined that the colors of the reference pixel and the comparison pixel are different in a case where the difference between the reference pixel and the comparison pixel exceeds a threshold.

6. The colorimetry method according to claim 2,
wherein in the acquiring of the spectroscopic measurement results, spectroscopic images with a plurality of wavelengths are acquired, and
in the determining, whether or not a plurality of colors is included based on the brightness value of a first pixel of the spectroscopic image with a first wavelength and the brightness value of a second pixel of the spectroscopic image with a first wavelength from the spectroscopic images with a plurality of wavelengths, and the brightness value of the first pixel of a spectroscopic image with a second wavelength, and the brightness value of the second pixel of the spectroscopic image with the second wavelength from the spectroscopic images with a plurality of wavelengths is determined.

7. The colorimetry method according to claim 1, further comprising:
acquiring spectroscopic images with a plurality of wavelengths for an object; and
generating a color image as the image by synthesizing the spectroscopic images with a plurality of wavelengths.

8. The colorimetry method according to claim 1,
wherein in the acquiring of the colorimetry results, the colorimetry results for the first color in the colorimetry range are acquired as the average value.

9. The colorimetry method according to claim 1,
wherein in the acquiring of the colorimetry results, the respective colorimetry results for the plurality of colors and the occupancy ratio in the colorimetry range are acquired in a case where a plurality of colors is included in the colorimetry range.

10. A colorimetry device that is configured to:
acquire spectroscopic measurement results for a colorimetry range in an image; and
acquire colorimetry results based on the spectroscopic measurement results for a first color from the plurality of colors in a case where a plurality of colors is included in the colorimetry range.

11. A printing apparatus, comprising:
the colorimetry device according to claim 10; and
a printing unit that prints an image as an object on a medium.
